(19) United States
(12) Patent Application Publication
(10) Pub. No.: US 2011/0131305 A1
(43) Pub. Date: Jun. 2, 2011

(54) SYSTEM FOR THE CREATION AND CONFIGURATION OF A NETWORK OF DEVICES

(75) Inventors: Daniele Venzano, Genova (IT); Alberto Ubertelli, Ceranesi (IT)

(73) Assignee: REGGIANE CRANES AND PLANTS S.P.A., Reggio (IT)

(21) Appl. No.: 12/994,139

(22) PCT Filed: May 20, 2009
(86) PCT No.: PCT/IB09/05662

§ 371 Date: Jan. 24, 2011

(30) Foreign Application Priority Data
May 21, 2008 (IT) MO2008A000148

(51) Int. Cl. G06F 15/177

(52) U.S. Cl. 709/222

(57) ABSTRACT

The system for the creation and configuration of a network of devices includes design modules for designing the configuration of a network of devices and automatic generation modules for automatically generating the management and control code of the network of devices starting from the designed configuration. The design modules are provided with a first configuration module of the parameters and the messages of the devices of the network of devices, with a second configuration module of a management and control graphic interface of the devices of the network of devices and with a realization module of a graphic model of the network of devices.

### TECHNICAL FIELD

The present invention relates to a system for the creation and configuration of a network of devices, particularly of the type of a system used for the rapid development of applications suitable for the management and the control of multibus networks of devices in the industrial automation or automotive sectors.

### BACKGROUND ART

The use is known of systems for the rapid development of applications, also known by the acronym RAD (Rapid Application Development), which permit the development of control and automation software for devices or networks, and which do not require the user to have particular programming skills or the detailed knowledge of specific languages or platforms for the development of applications.

Such systems are used, for example, to develop applications dedicated to controlling user interface devices, such as the so-called HMI (Human Machine Interface) devices, or to develop applications dedicated to controlling devices such as PLCs (Programmable Logic Controllers) within the field of industrial automation or ECU (Electronic Control Unit) devices in the automotive industry.

The known systems generally comprise:
design means for designing the configuration of one or more networks of proprietary devices in a finite and defined group of devices and types of networks;
automatic generation means for the automatic generation of the management and control code of the network of proprietary devices starting with the designed configuration.

In particular, the design means can be used by a user to configure the parameters and the messages of the network devices and to configure one or more management and control graphic interfaces for one or more of the network devices.

Subsequently, the generated management and control code is compiled, for example, by means of a top-level compiler, to make the executable code of the network devices.

These known systems, however, are susceptible to upgrading, aimed in particular at making the initial design phase of the network of devices easier and quicker.

### OBJECT OF THE INVENTION

The main aim of the present invention is to provide a system for the creation and automatic configuration of multibus networks of non-proprietary devices, that allows creating and configuring one or more networks and/or devices in a simple and quick way.

A further object of the present invention is to provide a system for the creation and automatic configuration of a network of devices which permits achieving the mentioned upgrading in the ambit of a simple, rational, easy, effective to use and low cost solution.

The above objects are achieved by the present system for the creation and configuration of a network of devices, comprising design means for designing the configuration of at least a network of devices and automatic generation means for automatically generating the management and control code of said network of devices starting from said designed configuration, said design means being provided with first configuration means of the parameters and the messages of at least one of the devices of said network of devices and with second configuration means of a management and control graphic interface of at least one of the devices of said network of devices, characterized in that said design means comprise realisation means of at least a graphic model of said network of devices.

### BRIEF DESCRIPTION OF THE DRAWINGS

Other characteristics and advantages of the present invention will become more evident from the description of a preferred, but not sole, embodiment of a system for the creation and configuration of a network of devices, illustrated purely as an example but not limited to the annexed drawings in which:

FIG. 1 is a general diagram of the system according to the invention.

### EMBODIMENTS OF THE INVENTION

With particular reference to such figures, by S is globally indicated a system for the creation and configuration of a network of devices, particularly of the type used for the rapid development of applications suitable for the management and the control of networks of devices in the industrial automation or automotive sectors.

With particular but not sole reference to the present description, it is pointed out that by the expression “networks of devices”, is meant networks in which one or more channels, such as buses of the CAN2.0A/B, Flex-Ray, RS232, RS422, RS485, Ethernet types and other field buses, with CanOpen, J1939, ISOBUS, NMEA2000 protocols, etc., link up a plurality of human machine interfaces and/or a plurality of management and control devices such as PLCs (Programmable Logic controller), ECUs (Electronic Control Unit), etc.

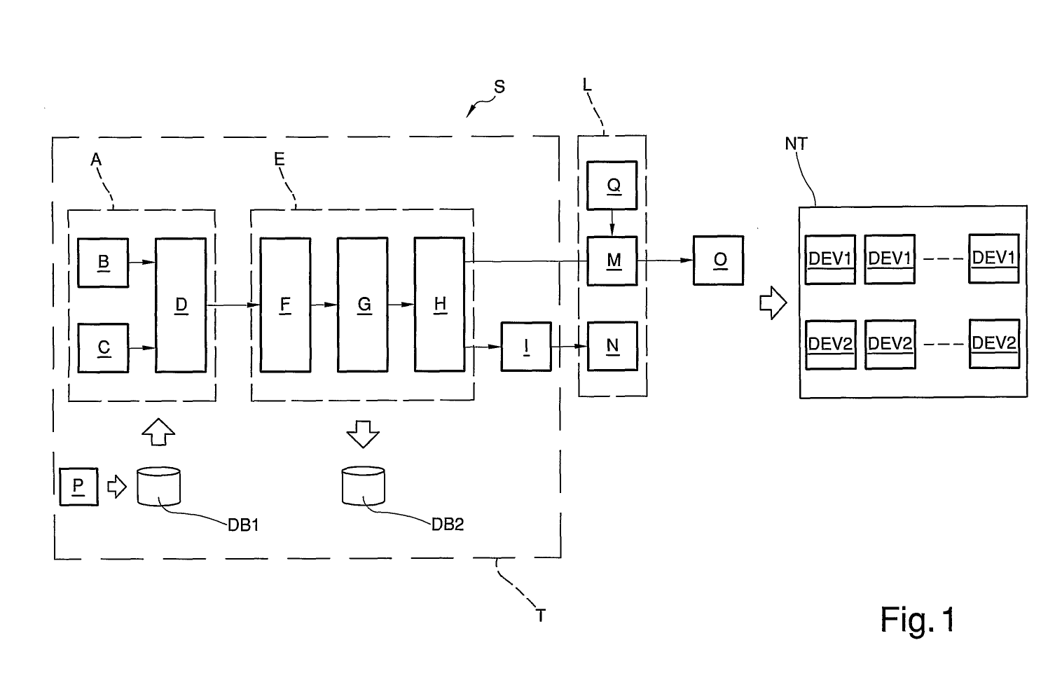

Such network of devices is generically indicated in FIG. 1 with the reference NT and is considered defined by one or more channels linking together several first devices DEVI, of the management and control device type, and several second devices DEV2, of the human machine interface device type.

The system S comprises design means T suitable for allowing a user to design the configuration of one or more networks of devices NT.

The system S also comprises automatic generation means L for the automatic generation of the management and control code of the network of devices NT, starting with the initially designed configuration.

In particular, the design means T comprise realisation means of at least a graphic model of the network of devices NT, indicated altogether in FIG. 1 by the reference A. In point of fact, the user of the design means T has at disposal a graphic interface suitable for allowing the reproduction of a graphic model of the network of devices NT to be configured.

The realisation means A of the graphic model comprise first selection means B, suitable for allowing the user to select one or more models of first or second devices DEV1 or DEV2 of the network of devices NT, selected from a predefined group of possible models of available first or second devices DEV1 or DEV2. More specifically, device models can be selected of the control unit, board, sensor, display type, etc.

Furthermore, the realisation means A of the graphic model comprise second selection means C, suitable for allowing the user to select one or more channel models for the electronic connection of a plurality of first or second devices DEV1 or DEV2, selected from a predefined group of possible available channel models. In this specific case, channel models can be selected such as buses of the CAN2.0A/B, Flex-Ray, RS232, RS422, RS485, Ethernet type and other field buses, with CanOpen, J1939, ISOBUS, NMEA2000 or other protocols. Usefully, both the models of the first or second devices DEV1 and DEV2 and the models of the connection channels between such devices can be stored inside a suitable first memory unit DB1 of the system S, of the mass memory type or the like.

Furthermore, the system S has entering means P usable by an operator to store new models of first or second devices DEV1 and DEV2 inside the first memory unit DB1.

Advantageously, the realisation means A provide means for drawing the graphic model of the network of devices NT, schematized in FIG. 1 with the block D, made starting with the models of the first or second selected devices DEV1, and DEV2 and with the models of the selected channels.

In particular, the means for the drawing D can have a suitable drawing area on the graphic interface of the system S, on which the user can arrange the models of the first or second selected devices DEV1 and DEV2, connecting these suitably the one to the other with the selected communication channel.

Furthermore, the design means T have first configuration means E, suitable for allowing the user to configure the parameters and the messages of the first or second selected devices DEV1 and DEV2 and arranged inside the graphic model of the network of devices NT.

In particular, the first configuration means E comprise first definition means F for defining the parameters of each of the first or the second devices DEV1 and DEV2. Such parameters can comprise, for example, attributes such as parameter name, unit, parameter type, current value, default value, minimum and maximum values, description of parameter, etc.

The first configuration means E also comprise second definition means G for defining the messages and the variables shared by the first or the second selected devices DEV1 and DEV2 and arranged inside the graphic model of the network of devices NT. Such messages can have attributes such as, for example, message name, sender, identification, transmission times, number of message bytes, description of the message, etc., according to the definition of the communication protocol between the devices. The shared variables can contain information such as, for example, name of variable, type of variable, position in bytes/bits inside the message, description of the variable or other additional information.

The first configuration means E can also comprise third definition means H for defining the persistent variables of the network of first or second selected devices DEV1 and DEV2 and arranged inside the graphic model of the network of devices NT, such as system setting parameters, etc.

Usefully, the design means T have second configuration means I, suitable for allowing the user to configure a graphic interface for the second user interface (HMI) devices DEV2 selected and arranged inside the graphic model of the network of devices NT.

In particular, the second configuration means I comprise means for the realisation of one or more interlinked graphic pages, each of which has one or more functional elements that can be selected or in any case viewed by an operator of the network of devices NT for the management and/or control of the first devices DEV1. Such functional elements can be positioned inside the graphic page, can be configured by the user and by the system S and can comprise, for example, images, static or dynamic text, buttons associable with predetermined events, progressive bars, hands, date/time, etc.

Usefully, the parameters of the first or second devices DEV1 and DEV2, the messages and the variables shared by such devices, the persistent variables of the network of devices NT and the above graphic page, can be stored inside a suitable second memory unit DB2 of the system. S, of the type of a mass memory or the like.

As shown in FIG. 1, the above automatic generation means L for the automatic generation of the management and control code comprise first creation means M, suitable for creating the parameters and the messages configured by the user of the system S by means of the first configuration means E. In point of fact, the first creation means M generate a first configuration file, such as a source file in language “C” or other language (CoDeSys, assembler or other high-level language).

Subsequent compilation means O of the management and control code, of the type of a compiler C or. other language (CoDeSys, assembler or other high-level language), allow generating a code that can be executed by the first or second devices DEV1 and DEV2 of the network of devices NT.

Usefully, the creation means M can comprise selection means Q for selecting the source code format, before the creation of the source file.

The automatic generation means L for the generation of the management and control code also comprise second creation means N, suitable for creating the graphic interface for the second devices DEV2 previously configured by the user of the system S by means of the second configuration means I.

Usefully, the system S can comprise means for updating the management and control code for one or more first or second devices DEV1 or DEV2 to be updated by means of loading of the updated code.

Furthermore, the system S can comprise means for recording events during the operation of the network of devices NT. The recorded events can comprise, e.g., active and historical alarms and pre-alarms, operating information predefined during the project phase and parameters relating to the operation of the communication channel.

Usefully, the system S can comprise means for identifying and authenticating operators in charge of one or more of the first or second devices DEV1 or DEV2 of the network of devices NT.

Furthermore, the system S can comprise means for allowing the remote access to the network of devices NT of operators in charge or for amendments to or updating of the management and control code.

In point of fact, it has been ascertained how the described invention achieves the proposed objects, and in particular the fact is underlined that the presence of the realisation means of a graphic model of the network of devices allows a more versatile configuration of the network of devices.

The invention thus conceived is susceptible to numerous modifications and variations, all of which falling within the scope of the inventive concept.

Furthermore all the details may be replaced with others that are technically equivalent.

In practice, the materials used, as well as the contingent shapes and dimensions, may be any according to requirements without because of this moving outside the protection scope of the following claims.

1) System for the creation and configuration of a network of devices, comprising design means for designing the configuration of at least a network of devices and automatic generation means for automatically generating the management and control code of said network of devices starting from said designed configuration, said design means being provided with first configuration means of the parameters and the messages of at least one of the devices of said network of devices and with second configuration means of a management and control graphic interface of at least one of the devices of said network of devices, characterized in that said design means comprise realisation means of at least a graphic model of said network of devices.

2) System according to the claim 1, characterized in that said realisation means of a graphic model comprise first selection means of at least a model of a device from a predefined group of possible models of available devices.

3) System according to the claim 1, characterized in that said realisation means of a graphic model comprise second selection means of at least a model of a channel, suitable for electronically connecting a plurality of said devices, selected from a predefined group of possible models of available channels.

4) System according to one or more of the preceding claims, characterized in that said realisation means of a graphic model comprise means for the drawing of said graphic model of the network of devices starting with the models of the selected devices and with the models of the selected channels.

5) System according to one or more of the preceding claims, characterized in that it comprises at least a first memory unit suitable for storing at least one between said models of devices and said models of channels.

6) System according to one or more of the preceding claims, characterized in that said first configuration means comprise first definition means for defining the parameters of each of said devices.

7) System according to one or more of, the preceding claims, characterized in that said first configuration means comprise second definition means for defining the messages and the variables shared by said devices.

8) System according to one or more of the preceding claims, characterized in that said first configuration means comprise third definition means for defining the persistent variables of said network of devices.

9) System according to one or more of the preceding claims, characterized in that said second configuration means of a graphic interface comprise means for the realisation of at least one graphic page, which has at least one functional element for the management and/or control of at least one of the devices of said network of devices.

10) System according to one or more of the preceding claims, characterized in that it comprises at least a second memory unit suitable for storing at least one between the parameters of said devices, the messages and the variables shared by said devices, the persistent variables of said network of devices and said graphic page.

11) System according to one or more of the preceding claims, characterized in that said automatic generation means for the automatic generation of the management and control code comprise first creation means for creating the parameters and the messages configured by said first configuration means, for at least one of the devices to be programmed of said network of devices.

12) System according to one or more of the preceding claims, characterized in that said automatic generation means for the generation of the management and control code comprise second creation means of the graphic interface configured by said second configuration means, for at least one of the devices to be programmed of said network of devices.

13) System according to one or more of the preceding claims, characterized in that it comprises compilation means of said management and control code for the generation of a code that can be executed by at least one of the devices of said network of devices.

14) System according to one or more of the preceding claims, characterized in that it comprises means for updating the management and control code for at least one of the devices of said network of devices.

15) System according to one or more of the preceding claims, characterized in that it comprises means for recording events during the operation of said network of devices.

16) System according to one or more of the preceding claims, characterized in that it comprises means for identifying and authenticating operators in charge of at least one of the devices of said network of devices.

17) System according to one or more of the preceding claims, characterized in that it comprises means for the remote access to at least one of the devices of said network of devices.
